(19) United States
(12) Patent Application Publication
(10) Pub. No.: US 2024/0037416 A1
(43) Pub. Date: Feb. 1, 2024

(54) SYSTEM AND METHOD FOR TEST-TIME ADAPTATION VIA CONJUGATE PSEUDOLABELS

(71) Applicants: Robert Bosch GmbH, Stuttgart (DE); Carnegie Mellon University, Pittsburgh, PA (US)

(72) Inventors: Mingjie SUN, Pittsburgh, PA (US); Sachin GOYAL, Pittsburgh, PA (US); Aditi RAGHUNATHAN, Pittsburgh, PA (US); Jeremy KOLTER, Pittsburgh, PA (US); Wan-Yi LIN, Wexford, PA (US)

(21) Appl. No.: 17/868,267

(22) Filed: Jul. 19, 2022

(51) Int. Cl. G06N 5/02

(52) U.S. Cl. CPC G06N 5/022

(57) ABSTRACT

A computer-implemented system and method relate to test-time adaptation of a machine learning system from a source domain to a target domain. Sensor data is obtained from a target domain. The machine learning system generates prediction data based on the sensor data. Pseudo-reference data is generated based on a gradient of a predetermined function evaluated with the prediction data. Loss data is generated based on the pseudo-reference data and the prediction data. One or more parameters of the machine learning system is updated based on the loss data. The machine learning system is configured to perform a task in the target domain after the one or more parameters has been updated.

### TECHNICAL FIELD

This disclosure relates generally to adapting a machine learning system to a distribution shift at test-time.

### BACKGROUND

Most modern deep networks perform well on new test inputs that are close to the training distribution. However, this performance dramatically decreases on test inputs drawn from a different distribution. While there is a large body of work on improving the robustness of models, most robust training methods are highly specialized to their setting. For example, they assume pre-specified perturbations, subpopulations, and spurious correlations, or access to unlabeled data from the target distribution, and most methods offer close to no improvement on general distribution shifts beyond their training. Also, in practice, it is often cumbersome (or even impossible) to precisely characterize all possible distribution shifts a model could encounter and then train accordingly.

### SUMMARY

The following is a summary of certain embodiments described in detail below. The described aspects are presented merely to provide the reader with a brief summary of these certain embodiments and the description of these aspects is not intended to limit the scope of this disclosure. Indeed, this disclosure may encompass a variety of aspects that may not be explicitly set forth below.

According to at least one aspect, a computer-implemented method relates to adapting a machine learning system that is trained with training data in a first domain to operate with sensor data in a second domain. The method includes obtaining the sensor data from the second domain. The method includes generating, via the machine learning system, prediction data based on the sensor data. The method includes generating pseudo-reference data based on a gradient of a predetermined function evaluated with the prediction data. The method includes generating loss data based on the pseudo-reference data and the prediction data. The method includes updating parameter data of the machine learning system based on the loss data. The method includes performing, via the machine learning system, a task in the second domain after the parameter data has been updated. The method includes controlling an actuator based on the task performed in the second domain.

According to at least one aspect, a computer-implemented method relates to test-time adaptation of a machine learning system from a source domain to a target domain. The machine learning system is trained with training data of the source domain. The method includes obtaining sensor data from the target domain. The method includes generating, via the machine learning system, prediction data based on the sensor data. The method includes generating loss data based on a negative convex conjugate of a predetermined function applied to a gradient of the predetermined function. The predetermined function is evaluated based on the prediction data. The method includes updating parameter data of the machine learning system based on the loss data. The method includes performing, via the machine learning system, a task in the target domain after the parameter data has been updated. The method includes controlling an actuator based on the task performed in the target domain.

According to at least one aspect, a system includes at least a processor and a non-transitory computer readable medium. The non-transitory computer readable medium is in data communication with the processor. The non-transitory computer readable medium has computer readable data including instructions stored thereon that, when executed by the processor, cause the processor to perform a method for adapting a machine learning system that is trained with training data in a first domain to operate with sensor data in a second domain. The method includes obtaining the sensor data from the second domain. The method includes generating, via the machine learning system, prediction data based on the sensor data. The method includes generating pseudo-reference data based on a gradient of a predetermined function evaluated with the prediction data. The method includes generating loss data based on the pseudo-reference data and the prediction data. The method includes updating parameter data of the machine learning system based on the loss data. The method includes performing, via the machine learning system, a task in the second domain after the parameter has been updated.

These and other features, aspects, and advantages of the present invention are discussed in the following detailed description in accordance with the accompanying drawings throughout which like characters represent similar or like parts.

### BRIEF DESCRIPTION OF THE DRAWINGS

FIG. 1 is a block diagram of an example of a system relating to test-time adaptation according to an example embodiment of this disclosure.

FIG. 2 is a flow diagram of an example of a process for adapting the machine learning system from a source domain to a target domain at test-time according to an example embodiment of this disclosure.

FIG. 3 is a flow diagram of another example of a process for adapting the machine learning system from a source domain to a target domain at test-time according to an example embodiment of this disclosure.

FIG. 4 is a diagram of an example of a system with the adapted machine learning system according to an example embodiment of this disclosure.

FIG. 5 is a diagram of the control system of FIG. 4 that is configured to control a mobile machine, which is at least partially or fully autonomous, according to an example embodiment of this disclosure.

FIG. 6 is a diagram of the control system of FIG. 4 that is configured to control a manufacturing machine of a manufacturing system, such as part of a production line, according to an example embodiment of this disclosure.

FIG. 7 depicts a schematic diagram of the control system of FIG. 4 that is configured to control a power tool having at least a partially autonomous mode according to an example embodiment of this disclosure.

FIG. 8 depicts a schematic diagram of the control system of FIG. 4 that is configured to control an automated personal assistant according to an example embodiment of this disclosure.

FIG. 9 depicts a schematic diagram of the control system of FIG. 4 that is configured to control a monitoring system according to an example embodiment of this disclosure.

FIG. 10 depicts a schematic diagram of the control system of FIG. 4 that is configured to control a medical imaging system according to an example embodiment of this disclosure.

### DETAILED DESCRIPTION

The embodiments described herein, which have been shown and described by way of example, and many of their advantages will be understood by the foregoing description, and it will be apparent that various changes can be made in the form, construction, and arrangement of the components without departing from the disclosed subject matter or without sacrificing one or more of its advantages. Indeed, the described forms of these embodiments are merely explanatory. These embodiments are susceptible to various modifications and alternative forms, and the following claims are intended to encompass and include such changes and not be limited to the particular forms disclosed, but rather to cover all modifications, equivalents, and alternatives falling with the spirit and scope of this disclosure.

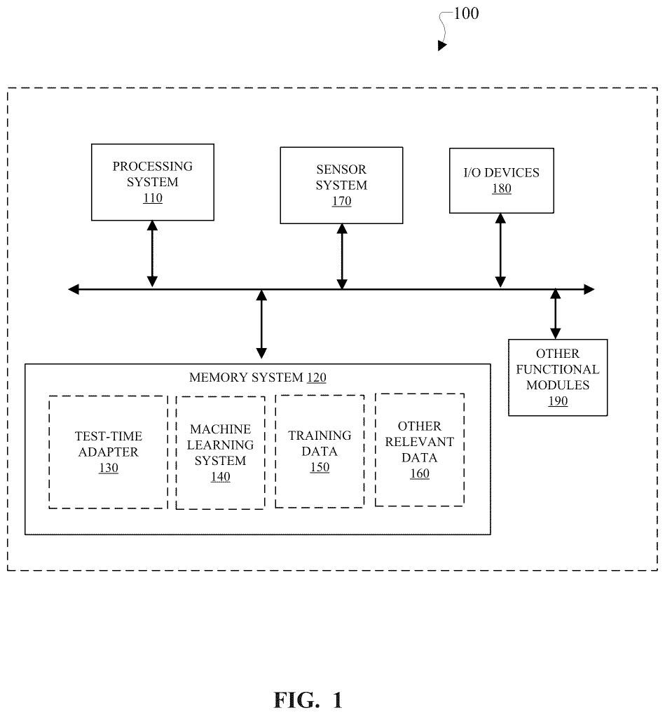

FIG. 1 is a diagram of a non-limiting example of a system 100, which is configured to train, employ, and/or deploy at least one machine learning system 140 according to an example embodiment of this disclosure. In addition, the system 100 is configured to adapt a trained machine learning system 140 from a source domain to a target domain at test-time by updating the parameter data (e.g., model parameters) of the machine learning system 140 based on a set of unlabeled sensor data from the target domain. More specifically, the system 100 is configured to consider a loss function [symbol] (h_{θ}(x), y) between the output data of the machine learning system h_{θ}(x) (e.g., the logit outputs of a classifier, or the direct prediction of a regressor) and target data y, as expressed in equation 1 for a predetermined function (denoted as “f”). For simplicity of notation, in some instances, h_{θ}(x) is denoted as “h” in this disclosure.

In an example embodiment, the predetermined function is a loss function of the machine learning system 140. More specifically, the predetermined function is set to be the same loss function that was used when the machine learning system 140 was trained with training data in the source domain. The system 100 uses the loss function to determine loss data associated with the task (e.g., classification) being performed by the machine learning system 140. The predetermined function may include any suitable loss function. For example, the predetermined function may include a cross-entropy loss function, a squared loss function, a hinge loss function, a tangent loss function, a polyloss function, a logistic loss function, any suitable loss function, or any number and combination thereof. For instance, with respect to the cross-entropy loss, the system 100 uses f(h)=log Σᵢ exp(hᵢ) as the predetermined function. As another example, for squared loss, the system 100 uses f (h)=½|h|₂².

[symbol]

(h_{θ}(x),y)=f(h_{θ}(x))−y^{T}h_{θ}(x) [1]

For example, when training an over-parameterized classifier, the system 100 performs the training process as (approximately) attaining the minimum over h_{θ}(x) for each training example. In this regard, the training process of optimizing h_{θ}(x) over the training dataset {xᵢ, yᵢ|i=1, . . . , n} can be formalized by the system 100 with equation 2.

$${min}_{θ} \frac{1}{n} {\sum }_{i = 1}^{n} ℒ ( {h}_{θ} ( {x}_{i} ) , {y}_{i} ) \approx \frac{1}{n} {\sum }_{i = 1}^{n} {min}_{h} ℒ ( {h}_{θ} ( {x}_{i} ) , {y}_{i} ) \qquad [ 2 ]$$

In the case of losses in the form of equation 1, the system 100 is configured to determine that the minimization of h in this form represents a specific optimization problem, specifically the convex conjugate of the predetermined function (i.e., f), where f* denotes the convex conjugate of the predetermined function f, as indicated in equation 3.

$${min}_{h} ℒ ( h , y ) \approx {min}_{h} \{ f ( h ) - {y}^{T} h \} = - {f}^{*} ( y ) \qquad [ 3 ]$$

As indicated, f* is a convex function in y (and is convex regardless of whether or not the predetermined function f is convex). Furthermore, for the case that the predetermined function f is convex differentiable, the optimality condition of this minimization problem is given by ∇f(h*)=y, thereby providing equation 4.

f*(y)=f*(∇f(h*)) [4]

Putting this all together informally, under the assumption that θ* is chosen so as to approximately minimize the empirical loss on the source data in the overparameterized setting, then the system 100 is also configured to include and use equation 5.

$$\frac{i}{n} {\sum }_{i = 1}^{n} ℒ ( {h}_{θ *} ( {x}_{i} ) , {y}_{i} ) \approx \frac{1}{n} {\sum }_{i = 1}^{n} - {f}^{*} ( ∇ f ( {h}_{θ *} ( {x}_{i} ) ) ) \qquad [ 5 ]$$

In equation 5, the system 100 is configured to approximate the empirical loss by the negative conjugate applied to the gradient of the predetermined function f, at least in a region close to the optimal θ* that minimizes the empirical loss. This later expression has the notable benefit of not requiring any ground-truth label yᵢ to compute the loss, and thus can be used as a basis for the test-time adapter 130 with respect to the target domain of the machine learning function h*_{θ}(x).

Referring to the loss function that takes the form given in equation 1, used for training the machine learning system h_{θ}(x) (e.g., a classifier) in the over-parameterized regime, the system 100 defines the conjugate adaptation loss [symbol] ^{conj}(h_{θ}(x)): [symbol] ^{|y|} [symbol] [symbol] as expressed in equation 6.

[symbol]

^{conj}(h_{θ}(x))=−f*(∇f(h_{θ}(x)))=f(h_{θ}(x))−∇f(h_{θ}(x))^{T}h_{θ}(x) [6]

With respect to these approximations, the system 100 includes and uses an additional simple interpretation of the conjugate loss: it is also equal to the original loss (as expressed in equation 1) applied to the “pseudo-labels” (or the pseudo-reference data) of y_{θ}^{CPL}(x)=∇f(h_{θ}(x)), where CPL refers to conjugate pseudo-labels.

[symbol]

^{conj}(h_{θ}(x))=−f*(∇f(h_{θ}(x)))=f(h_{θ}(x))−∇f(h_{θ}(x))^{T}h_{θ}(x)= [symbol] (h_{θ}(x),∇f(h_{θ}(x))) [7]

In accordance with the property known as the Fenchel-Young inequality that is f (x)+f*(u)≤x^{T}u holding with equality when u=∇f(x), the system 100 uses a conjugate adaptation loss that is precisely equivalent to self-training under the specific soft pseudo-labels given by y_{θ}^{CPL}(X)=∇f(h_{θ}(X)). For many cases, this may be a more convenient form for the system 100 to compute than explicitly computing the conjugate function.

Referring to FIG. 1, the system 100 includes at least a processing system 110 with at least one processing device. For example, the processing system 110 includes at least an electronic processor, a central processing unit (CPU), a graphics processing unit (GPU), a microprocessor, a field-programmable gate array (FPGA), an application-specific integrated circuit (ASIC), any suitable processing technology, or any number and combination thereof. The processing system 110 is operable to provide the functionality as described herein.

The system 100 includes a memory system 120, which is operatively connected to the processing system 110. In an example embodiment, the memory system 120 includes at least one non-transitory computer readable storage medium, which is configured to store and provide access to various data to enable at least the processing system 110 to perform the operations and functionality, as disclosed herein. In an example embodiment, the memory system 120 comprises a single memory device or a plurality of memory devices. The memory system 120 can include electrical, electronic, magnetic, optical, semiconductor, electromagnetic, or any suitable storage technology that is operable with the system 100. For instance, in an example embodiment, the memory system 120 can include random access memory (RAM), read only memory (ROM), flash memory, a disk drive, a memory card, an optical storage device, a magnetic storage device, a memory module, any suitable type of memory device, or any number and combination thereof. With respect to the processing system 110 and/or other components of the system 100, the memory system 120 is local, remote, or a combination thereof (e.g., partly local and partly remote). For example, the memory system 120 can include at least a cloud-based storage system (e.g. cloud-based database system), which is remote from the processing system 110 and/or other components of the system 100.

The memory system 120 includes at least a test-time adapter 130, the machine learning system 140, training data 150, and other relevant data 160, which are stored thereon. The test-time adapter 130 includes computer readable data with instructions, which, when executed by the processing system 110, is configured to adapt at least one machine learning system 140 from a source domain to a target domain. The machine learning system 140 is trained with training data in the source domain. The computer readable data can include instructions, code, routines, various related data, any software technology, or any number and combination thereof. In an example embodiment, the machine learning system 140 includes at least one artificial neural network model and/or any suitable machine learning model, which is configured to perform a classification task. In this regard, for example, the machine learning system 140 includes at least one classifier (e.g., ResNet or any suitable classification model). For example, the machine learning system 140 is configured to map an input x∈ [symbol] ^{d} to a label y∈Y. The machine learning system 140 includes a machine learning model h_{θ}: [symbol] ^{d} [symbol] [symbol] ^{|y|}, parameterized by θ, that maps an input x to predictions h_{θ}(x).

Also, the training data 150 includes a sufficient amount of sensor data in the source domain, label data associated with the sensor data in the source domain, various loss data, various weight data, and various parameter data, as well as any related machine learning data that enables the machine learning system 140 to perform the functions as described in this disclosure. The training data 150 also includes at least a test dataset Dₜₑₛₜ in the target domain. The test dataset Dₜₑₛₜ does not include any ground-truth label data associated with its test samples (e.g., sensor data) in the target domain. Meanwhile, the other relevant data 160 provides various data (e.g. operating system, etc.), which enables the system 100 to perform the functions as discussed herein.

The system 100 is configured to include at least one sensor system 170. The sensor system 170 includes one or more sensors. For example, the sensor system 170 includes an image sensor, a camera, a radar sensor, a light detection and ranging (LIDAR) sensor, a thermal sensor, an ultrasonic sensor, an infrared sensor, a motion sensor, an audio sensor (e.g., microphone), any suitable sensor, or any number and combination thereof. The sensor system 170 is operable to communicate with one or more other components (e.g., processing system 110 and memory system 120) of the system 100. For example, the sensor system 170 may provide sensor data, which is then used by the processing system 110 to generate digital image data and/or digital audio data based on the sensor data. In this regard, the processing system 110 is configured to obtain the sensor data directly or indirectly from one or more sensors of the sensor system 170. The sensor system 170 is local, remote, or a combination thereof (e.g., partly local and partly remote). Upon receiving the sensor data, the processing system 110 is configured to process this sensor data (e.g. image data) in connection with the test-time adapter 130, the machine learning system 140, the training data 150, the other relevant data 160, or any number and combination thereof.

In addition, the system 100 may include at least one other component. For example, as shown in FIG. 1, the memory system 120 is also configured to store other relevant data 160, which relates to operation of the system 100 in relation to one or more components (e.g., sensor system 170, I/O devices 180, and other functional modules 190). In addition, the system 100 is configured to include one or more I/O devices 180 (e.g., display device, keyboard device, speaker device, etc.), which relate to the system 100. Also, the system 100 includes other functional modules 190, such as any appropriate hardware, software, or combination thereof that assist with or contribute to the functioning of the system 100. For example, the other functional modules 190 include communication technology (e.g. wired communication technology, wireless communication technology, or a combination thereof) that enables components of the system 100 to communicate with each other as described herein. In this regard, the system 100 is operable to at least train, adapt, employ, and/or deploy the machine learning system 140 (and/or test-time adapter 130), as described herein.

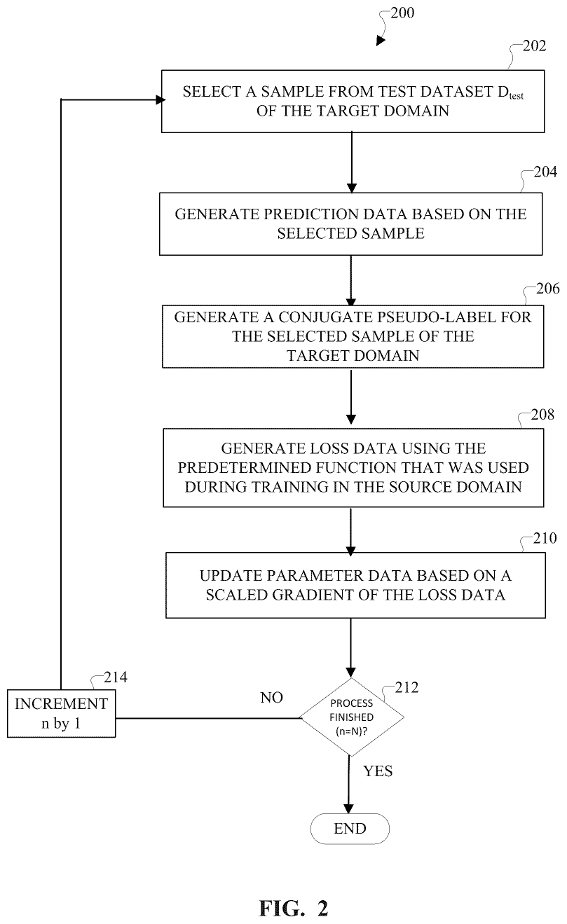

FIG. 2 is a flow diagram of an example of a process 200 for adapting the machine learning system 140 from a source domain to a target domain at test-time. In an example embodiment, the process 200 is performed, via the test-time adapter 130, by one or more processors of the processing system 110. The process 200 may include more steps or less steps than that shown in FIG. 2 provided that the machine learning system 140 is adapted, via conjugate pseudo-labels (or pseudo-reference data) at test-time, as described herein.

As a general overview, the process 200 may be expressed, for example, as the following algorithm.

Algorithm: Conjugate pseudo-labeling (Conjugate PL)

```
Hyperparams: learning rate n and temperature T.
Input: Source classifier θ₀ trained using loss [symbol]  (h_{θ}(x), y) = f(h_{θ}(x)) −
y^{T}h_{θ}(x).
Hyperparams: learning rate η and temperature T.
  Let h̅₀(x) [symbol]     h₀(x)/T be the temperature scaled predictor.
  Let y₀^{CPL}(x) denote the conjugate pseudo-label function y_{θ}^{CPL}(x) =
  ∇(f(h̅_{θ}(x))).
  for n = 0, 1, . . . N − 1 do
    Sample xₙ ~ Dₜₑₛₜ.
    θₙ₊₁ = θₙ − η∇ [symbol]    (h_{θ}(xₙ), y_{θ}^{CPL} (xₙ)) [Self-training with conjugate
    pseudo-labels]
```

FIG. 2 also illustrates the process 200 for performing the test-time adaptation of the machine learning system 140 from the source domain to the target domain. More specifically, at step 202, in an example, the processing system 110 selects a sample from a test dataset Dₜₑₛₜ. The test dataset Dₜₑₛₜ includes a number of samples of input data (e.g., sensor data such as digital image data, digital audio data, etc.) from the target domain. As an example, for instance, the test dataset Dₜₑₛₜ may be represented as Dₜₑₛₜ={xᵢ|i=1, . . . , M}, where M represents a total number of test samples and is an integer value greater than 1. Unlike the training data that was used to train the machine learning system 140 in the source domain, the test dataset Dₜₑₛₜ comprises a set of sensor data without corresponding ground-truth labels.

At step 204, in an example, the processing system 110 generates prediction data based on the selected sample. The sample is selected in accordance with the iteration (e.g., counters or indexes n and i). In addition, the processing system 110, via the machine learning system 140 (e.g., classifier h_{θ}(xᵢ)), generates output data (e.g., prediction data such as a class label) based on the input data (e.g. the selected sample xᵢ from the test dataset Dₜₑₛₜ of the target domain).

At step 206, in an example, the processing system 110 generates a conjugate pseudo-label for the selected sample (e.g., xₙ) of the target domain. The conjugate pseudo-label may be referred to as pseudo-reference data. The conjugate pseudo-label represents an approximation of the ground-truth data and serves as a reference for the expected value of the output data. The processing system 110 generates the conjugate pseudo-label via y_{θ}^{CPL}(xᵢ)=∇f(h_{θ}(xᵢ)) and associates the conjugate pseudo-label with the input data xᵢ.

At step 208, in an example, the processing system 110 generates loss data using the predetermined function that was used when the machine learning system 140 was trained with training data (e.g., sensor data and label data) in the source domain. In this regard, for instance, if the machine learning system 140 was trained with a cross-entropy loss function in the source domain, then the processing system 110 uses the same cross-entropy loss function as the predetermined function to generate the loss data in the target domain. As another example, for instance, if the machine learning system 140 was trained with a squared loss function in the source domain, then the processing system 110 uses the same squared loss function as the predetermined function to generate the loss data in the target domain. For the selected sample (e.g. sensor data xᵢ), the processing system 110 determines the loss based on the prediction data y(xᵢ)=h_{θ}(xᵢ) of step 204 and the conjugate pseudo-label h_{θ}^{CPL}(xᵢ)=∇f(h_{θ}(xᵢ)) of step 206. The processing system 110 then uses the loss data at step 210.

At step 210, in an example, the processing system 110 updates parameter data based on a scaled gradient of the loss data. More specifically, the processing system 110 updates the parameter data θₙ₊₁ using equation 8, where η represents a scale factor. As indicated below, in equation 8, the processing system 110 updates parameter data θₙ₊₁ based on parameter data θₙ and a scaled gradient of the loss data [symbol] (h̅_{θ}(xₙ), h_{θ}^{CPL}(xₙ)).

θₙ₊₁=θₙ−η∇ [symbol] (h̅_{θ}(xₙ),y_{θ}^{CPL}(xₙ)) [8]

At step 212, in an example, the processing system 110 determines if the process 200 of adapting the machine learning system 140 to the target domain has been completed. For example, the processing system 110 makes this determination by comparing the value of the current counter n (or index n) with the predetermined threshold N, which is an integer value. Based on the comparison, if the current counter n is less than a predetermined threshold N, then the processing system 110 proceeds to step 214. Alternatively, if the current counter n is equal to the predetermined threshold N, then the processing system 110 is considered to have completed the process 200 of adapting the machine learning system 140 to the target domain based on the test dataset Dₜₑₛₜ of that target domain.

At step 214, in an example, the processing system 110 proceeds to increment the counter n (or the index n) and proceeds to step 202. For example, if n=1, then the processing system 110 increments the index by 1 such that n=2 before proceeding to step 202, where the processing system 110 goes through steps 202, 204, 206, 208, 210, and 212 using this updated index of n=2.

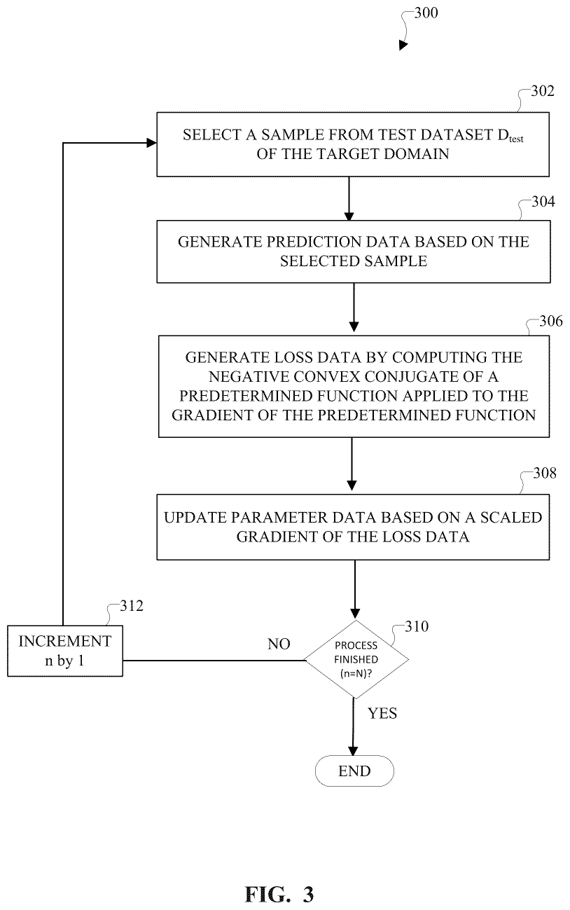

FIG. 3 is a flow diagram of another example of a process 300 for adapting the machine learning system from a source domain to a target domain at test-time. In an example embodiment, the process 200 is performed, via the test-time adapter 130, by one or more processors of the processing system 110. The process 300 may include more steps or less steps than that shown in FIG. 3 provided that the machine learning system 140 is adapted from the source domain to the target domain at test-time, as described herein.

At step 302, in an example, the processing system 110 selects a sample from a test dataset Dₜₑₛₜ. The test dataset Dₜₑₛₜ includes a number of samples of input data (e.g., sensor data such as digital image data, digital audio data, etc.) from the target domain. As an example, for instance, the test dataset Dₜₑₛₜ may be represented as Dₜₑₛₜ={xᵢ|i=1, . . . , M}, where M represents a total number of test samples and is an integer value greater than 1. Unlike the training data that was used to train the machine learning system 140 in the source domain, the test dataset Dₜₑₛₜ comprises a set of sensor data without corresponding ground-truth labels.

At step 304, in an example, the processing system 110 generates prediction data based on the selected sample. The sample is selected in accordance with the iteration (e.g., counters or indexes n and i). In addition, the processing system 110, via the machine learning system 140 (e.g., classifier h_{θ}(xᵢ)), generates output data (e.g., prediction data such as a class label) based on the input data (e.g. the selected sample xᵢ from the test dataset Dₜₑₛₜ of the target domain).

At step 306, in an example, the processing system 110 generates loss data by computing the negative convex conjugate of a predetermined function applied to the gradient of the predetermined function. More specifically, the processing system 110 generates loss data using equation 9 (or equation 7). In this regard, the processing system 110 generates the loss data based on the prediction data h_{θ}(xᵢ) using the predetermined function f. Moreover, as indicated in equation 9, the processing system 110 is configured to compute the loss based on the sample xᵢ without requiring a corresponding ground-truth label for that sample in the target domain. In this regard, step 306 of process 300 is equivalent to step 206 and step 208 of process 200, as indicated in equation 7, and provide the same or similar loss data.

[symbol]

^{conj}(h_{θ}(xᵢ))=−f*(∇f(h_{θ}(xᵢ))) [9]

At step 308, in an example, the processing system 110 updates parameter data based on a scaled gradient of the loss data. More specifically, the processing system 110 updates the parameter data θₙ₊₁ using equation 8, where η represents a scale factor. As indicated in equation 8, the processing system 110 updates parameter data θₙ₊₁ based on parameter data θₙ and a scaled gradient of the loss data [symbol] (h̅_{θ}(xₙ), y_{θ}^{CPL}(xₙ)).

At step 310, in an example, the processing system 110 determines if the process 300 of adapting the machine learning system 140 to the target domain has been completed. For example, the processing system 110 makes this determination by comparing the value of the current counter n (or index n) with the predetermined threshold N, which is an integer value. Based on the comparison, if the current counter n is less than a predetermined threshold N, then the processing system 110 proceeds to step 312. Alternatively, if the current counter n is equal to the predetermined threshold N, then the processing system 110 is considered to have completed the process 300 of adapting the machine learning system 140 to the target domain based on the test dataset Dₜₑₛₜ of that target domain.

At step 312, in an example, the processing system 110 proceeds to increment the counter n (or index n) and proceeds to step 302. For example, if n=1, then the processing system 110 increments the index by 1 such that n=2 before proceeding to step 302, where the processing system 110 goes through steps 302, 304, 306, 308, and 310 using this updated index of n=2.

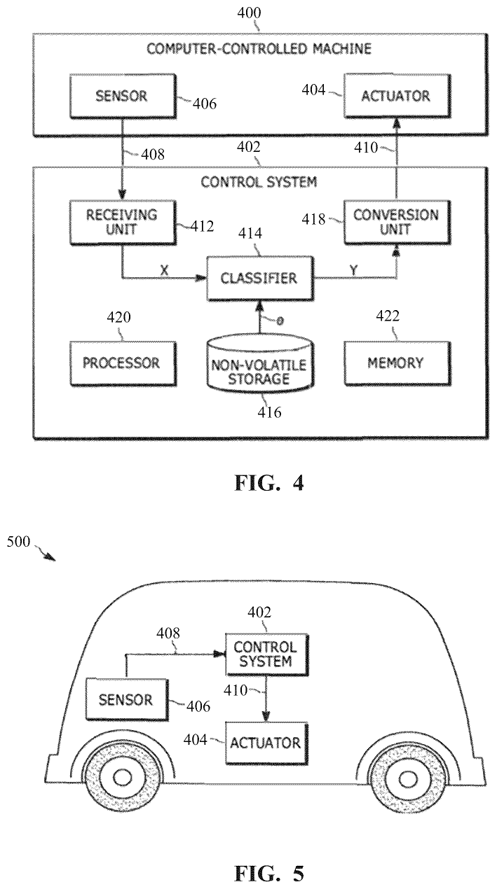

As described above, upon being trained in the source domain and adapted in the target main, the machine learning system 140 is then configured to be employed to actuate an actuator of a computerized control system in the source domain, the target domain, or a combination thereof. Several examples of computerized control systems are shown in FIGS. 4-10. In these embodiments, the machine learning systems 140 may be implemented in production for use as illustrated. Structure used for training and using the machine learning models for these applications (and other applications) are exemplified in FIG. 4.

FIG. 4 depicts a schematic diagram of an interaction between computer-controlled machine 400 and control system 402. Computer-controlled machine 400 includes actuator 404 and sensor 406. The actuator 404 may include one or more actuators. The sensor 406 may include one or more sensors. The sensor 406 is configured to sense a condition of computer-controlled machine 400. The sensor 406 may be configured to encode the sensed condition into sensor signals 408 and to transmit sensor signals 408 to control system 402. A non-limiting example of sensor 406 includes a camera, video, radar, LiDAR, an ultrasonic sensor, an image sensor, an audio sensor, a motion sensor, etc. In some embodiments, the sensor 406 is an optical sensor configured to sense optical images of an environment proximate to computer-controlled machine 400.

Control system 402 is configured to receive sensor signals 408 from computer-controlled machine 400. As set forth below, control system 402 may be further configured to compute actuator control commands 410 depending on the sensor signals and to transmit actuator control commands 410 to the actuator 404 of the computer-controlled machine 400.

As shown in FIG. 4, control system 402 includes receiving unit 412. Receiving unit 412 may be configured to receive sensor signals 408 from sensor 406 and to transform sensor signals 408 into input signals x. In an alternative embodiment, sensor signals 408 are received directly as input signals x without receiving unit 412. Each input signal x may be at least a portion of each sensor signal 408. Receiving unit 412 may be configured to process each sensor signal 408 to product each input signal x. Input signal x may include data corresponding to an image recorded by sensor 406.

Control system 402 includes classifier 414. Classifier 414 may be configured to classify input signals x into one or more labels using a machine learning (ML) algorithm via employing the trained machine learning system 140 (FIG. 1), which has been adapted according to a test time adaptation process (e.g., process 200 as described with respect to FIG. 2 and/or process 300 as described with respect to FIG. 3). Classifier 414 is configured to be parametrized by parameters, such as those described above (e.g., parameter θ). Parameters θ may be stored in and provided by non-volatile storage 416. Classifier 414 is configured to determine output signals y from input signals x. Each output signal y includes information that assigns one or more labels to each input signal x. Classifier 414 may transmit output signals y to conversion unit 418. Conversion unit 418 is configured to covert output signals y into control data that includes actuator control commands 410. Control system 402 is configured to transmit actuator control commands 410 to the actuator 404, which is configured to actuate computer-controlled machine 400 in response to actuator control commands 410. In some embodiments, the actuator 404 is configured to actuate computer-controlled machine 400 based directly on output signals y.

Upon receipt of actuator control commands 410 by the actuator 404, the actuator 404 is configured to execute an action corresponding to the related actuator control command 410 (or control data). The actuator 404 may include control logic configured to transform actuator control commands 410 into a second actuator control command, which is utilized to control the actuator 404. In one or more embodiments, actuator control commands 410 may be utilized to control a display instead of or in addition to the actuator 404.

In some embodiments, control system 402 includes sensor 406 instead of or in addition to computer-controlled machine 400 including sensor 406. Control system 402 may also include actuator 404 instead of or in addition to computer-controlled machine 400 including actuator 404. As shown in FIG. 4, control system 402 also includes processor 420 and memory 422. Processor 420 may include one or more processors. Memory 422 may include one or more memory devices. The classifier 414 (i.e., the trained machine learning system 140) of one or more embodiments may be implemented by control system 402, which includes non-volatile storage 416, processor 420, and memory 422.

Non-volatile storage 416 may include one or more non-transitory persistent data storage devices such as a hard drive, optical drive, tape drive, non-volatile solid-state device, cloud storage or any other device capable of persistently storing information. Processor 420 may include one or more devices selected from high-performance computing (HPC) systems including high-performance cores, graphics processing units, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 422. Memory 422 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 420 may be configured to read into memory 422 and execute computer-executable instructions residing in non-volatile storage 416 and embodying one or more ML algorithms and/or methodologies of one or more embodiments. Non-volatile storage 416 may include one or more operating systems and applications. Non-volatile storage 416 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL

Upon execution by processor 420, the computer-executable instructions of non-volatile storage 416 may cause control system 402 to implement one or more of the ML algorithms and/or methodologies to employ the trained machine learning system 140 as disclosed herein. Non-volatile storage 416 may also include ML data (including parameter data of the machine learning system 140) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable data including computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a non-transitory computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the diagrams may be re-ordered, processed serially, and/or processed concurrently consistent with one or more embodiments. Moreover, any of the flowcharts and/or diagrams may include more or fewer nodes or blocks than those illustrated consistent with one or more embodiments. Furthermore, the processes, methods, or algorithms can be embodied in whole or in part using suitable hardware components, such as ASICs, FPGAs, state machines, controllers or other hardware components or devices, or a combination of hardware, software and firmware components.

FIG. 5 depicts a schematic diagram of control system 402 configured to control vehicle 500, which may be at least a partially autonomous vehicle or a partially autonomous robot. Vehicle 500 includes actuator 404 and sensor 406. Sensor 406 may include one or more video sensors, cameras, radar sensors, ultrasonic sensors, LiDAR sensors, audio sensors, any suitable sensing device, or any number and combination thereof. One or more of the one or more specific sensors may be integrated into vehicle 500. Alternatively or in addition to one or more specific sensors identified above, sensor 406 may include a software module configured to, upon execution, determine a state of the actuator 404. One non-limiting example of a software module includes a weather information software module configured to determine a present or future state of the weather proximate to the vehicle 500 or at another location.

Classifier 414 of control system 402 of vehicle 500 may be configured to detect objects in the vicinity of vehicle 500 dependent on input signals x. In such an embodiment, output signal y may include information classifying or characterizing objects in a vicinity of the vehicle 500. Actuator control command 410 may be determined in accordance with this information. The actuator control command 410 may be used to avoid collisions with the detected objects.

In some embodiments, the vehicle 500 is an at least partially autonomous vehicle or a fully autonomous vehicle. The actuator 404 may be embodied in a brake, a propulsion system, an engine, a drivetrain, a steering of vehicle 500, etc. Actuator control commands 410 may be determined such that the actuator 404 is controlled such that vehicle 500 avoids collisions with detected objects. Detected objects may also be classified according to what classifier 414 deems them most likely to be, such as pedestrians, trees, any suitable labels, etc. The actuator control commands 410 may be determined depending on the classification.

In some embodiments where vehicle 500 is at least a partially autonomous robot, vehicle 500 may be a mobile robot that is configured to carry out one or more functions, such as flying, swimming, diving, stepping, etc. The mobile robot may be a lawn mower, which is at least partially autonomous, or a cleaning robot, which is at least partially autonomous. In such embodiments, the actuator control command 410 may be determined such that a propulsion unit, steering unit and/or brake unit of the mobile robot may be controlled such that the mobile robot may avoid collisions with identified objects.

In some embodiments, vehicle 500 is an at least partially autonomous robot in the form of a gardening robot. In such embodiment, vehicle 500 may use an optical sensor as sensor 406 to determine a state of plants in an environment proximate to vehicle 500. Actuator 404 may be a nozzle configured to spray chemicals. Depending on an identified species and/or an identified state of the plants, actuator control command 410 may be determined to cause actuator 404 to spray the plants with a suitable quantity of suitable chemicals.

Vehicle 500 may be a robot, which is at least partially autonomous and in the form of a domestic appliance. As a non-limiting example, a domestic appliance may include a washing machine, a stove, an oven, a microwave, a dishwasher, etc. In such a vehicle 500, sensor 406 may be an optical sensor configured to detect a state of an object which is to undergo processing by the household appliance. For example, in the case of the domestic appliance being a washing machine, sensor 406 may detect a state of the laundry inside the washing machine. Actuator control command 410 may be determined based on the detected state of the laundry.

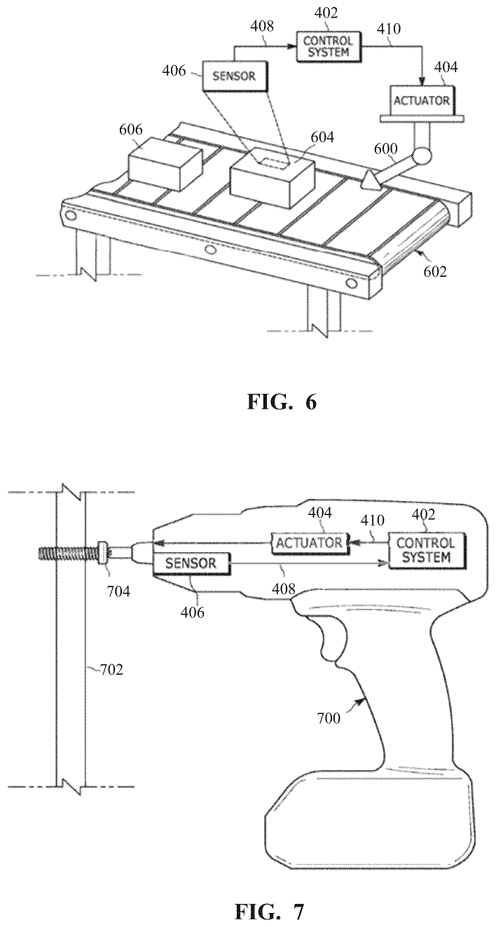

FIG. 6 depicts a schematic diagram of control system 402 configured to control a system 600 (e.g., manufacturing machine), which may include a punch cutter, a cutter, a gun drill, or the like, of a manufacturing system 602, such as part of a production line. Control system 402 may be configured to control actuator 404, which is configured to control the system 600 (e.g., manufacturing machine).

Sensor 406 of the system 600 (e.g., manufacturing machine) may be an optical sensor configured to capture one or more properties of a manufactured product 604. Classifier 414 may be configured to determine a state of manufactured product 604 from one or more of the captured properties. Actuator 404 may be configured to control the system 600 (e.g., manufacturing machine) depending on the determined state of a manufactured product 604 for a subsequent manufacturing step of the manufactured product 604. The actuator 404 may be configured to control functions of the system 600 (e.g., manufacturing machine) on a subsequent manufactured product 606 of system 600 (e.g., manufacturing machine) depending on the determined state of manufactured product 604.

FIG. 7 depicts a schematic diagram of control system 402, which is configured to control power tool 700. As a non-limiting example, the power tool 700 may be a power drill or a driver, which has at least a partially autonomous mode. Control system 402 may be configured to control actuator 404, which is configured to control the power tool 700.

Sensor 406 of power tool 700 may be an optical sensor configured to capture one or more properties of work surface 702 and/or fastener 704 being driven into work surface 702. Classifier 414 may be configured to determine a state of work surface 702 and/or fastener 704 relative to work surface 702 from one or more of the captured properties. The state may be fastener 704 being flush with work surface 702. The state may alternatively be hardness of work surface 702. Actuator 404 may be configured to control power tool 700 such that the driving function of power tool 700 is adjusted depending on the determined state of fastener 704 relative to work surface 702 or one or more captured properties of work surface 702. For example, actuator 404 may discontinue the driving function if the state of fastener 704 is flush relative to work surface 702. As another non-limiting example, actuator 404 may apply additional or less torque depending on the hardness of work surface 702.

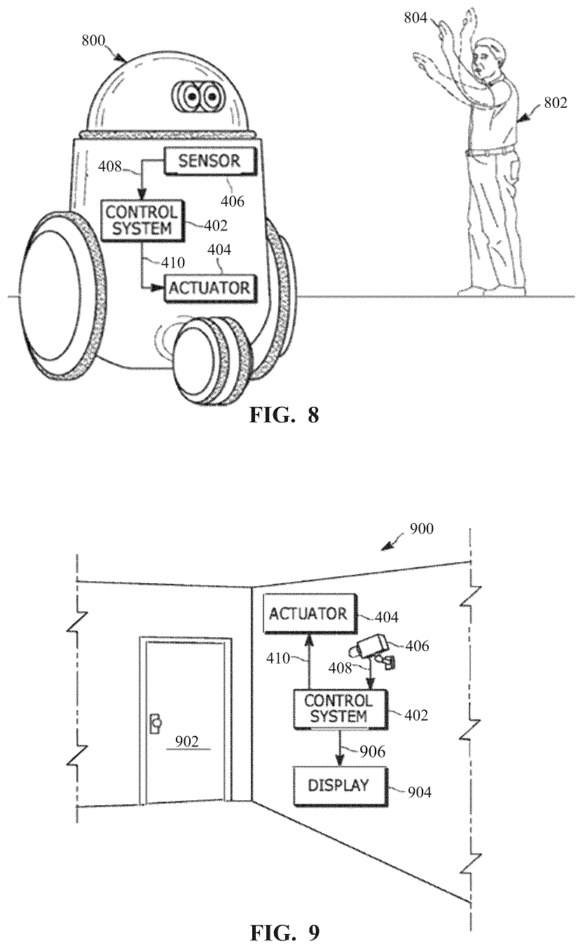

FIG. 8 depicts a schematic diagram of control system 402 configured to control automated personal assistant 800. Control system 402 may be configured to control actuator 404, which is configured to control automated personal assistant 800. Automated personal assistant 800 may be configured to control a domestic appliance, such as a washing machine, a stove, an oven, a microwave, a dishwasher, or the like. Sensor 406 may be an image sensor and/or an audio sensor. The image sensor may be configured to receive images or video of gestures 804 of user 802. The audio sensor may be configured to receive a voice command of user 802.

Control system 402 of automated personal assistant 800 may be configured to determine actuator control commands 410 configured to control system 402. Control system 402 may be configured to determine actuator control commands 410 in accordance with sensor signals 408 of sensor 406. Automated personal assistant 800 is configured to transmit sensor signals 408 to control system 402. Classifier 414 of control system 402 may be configured to execute a gesture recognition algorithm to identify gesture 804 made by user 802, to determine actuator control commands 410, and to transmit the actuator control commands 410 to actuator 404. Classifier 414 may be configured to retrieve information from non-volatile storage in response to gesture 804 and to output the retrieved information in a form suitable for reception by user 802.

FIG. 9 depicts a schematic diagram of control system 402 configured to control monitoring system 900. Monitoring system 900 may be configured to physically control access through door 902. Sensor 406 may be configured to detect a scene that is relevant in deciding whether access is granted. Sensor 406 may be an optical sensor configured to generate and transmit image and/or video data. Such data may be used by control system 402 to detect and classify an identity associated with a face of a person.

Classifier 414 of control system 402 of monitoring system 900 may be configured to interpret the image and/or video data by matching identities of known people stored in non-volatile storage 416, thereby determining an identity of a person. Classifier 414 may be configured to generate an actuator control command 410 in response to the interpretation of the image and/or video data. Control system 402 is configured to transmit the actuator control command 410 to actuator 404. In this embodiment, the actuator 404 is configured to lock or unlock door 902 in response to the actuator control command 410. In some embodiments, a non-physical, logical access control is also possible.

Monitoring system 900 may also be a surveillance system. In such an embodiment, sensor 406 may be an optical sensor configured to detect a scene that is under surveillance and the control system 402 is configured to control an I/O device, such as a display device 904. Classifier 414 is configured to determine a classification of a scene, e.g. whether the scene detected by sensor 406 is suspicious. Control system 402 is configured to transmit a display control command 906 to the display 904 in response to the classification. The display 904 may display content in response to the display control command 906. For instance, the display control command 906 may highlight a subject that is deemed suspicious by classifier 414 and display the highlighted subject on the display 904.

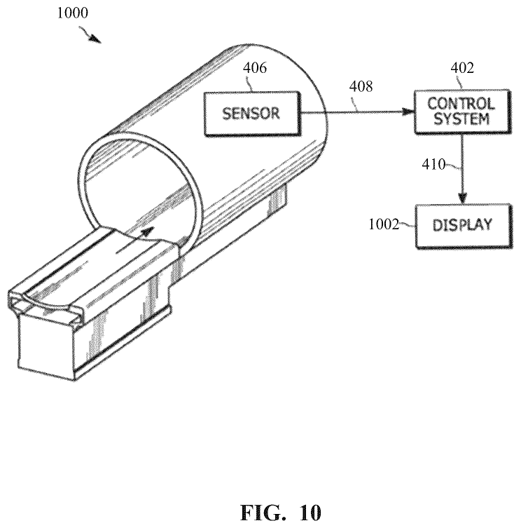

FIG. 10 depicts a schematic diagram of control system 402 configured to control imaging system 1000, for example a magnetic resonance imaging (MM) apparatus, x-ray imaging apparatus or ultrasonic apparatus. Sensor 406 may, for example, be an imaging sensor. Classifier 414 may be configured to determine a classification of all or part of the sensed image. Classifier 414 may be configured to determine or select an actuator control command 410 in response to the class label, which is generated as output by the classifier 414. For example, classifier 414 may interpret a region of a sensed image to be potentially anomalous. In this case, the actuator control command 410 may be selected to cause display 1002 to display the image and highlight the potentially anomalous region.

As discussed above, the embodiments are effective in adapting machine learning systems 140 to distribution shifts and/or new domains, thereby overcoming the technical problems (e.g., dramatically decreased performance) that would otherwise occur when unadapted machine learning systems operate on input data associated with distributions, which are different than the distributions of the training data that trained these machine learning systems. This technical problem can occur in a variety of instances, such as when a partially or fully autonomous vehicle includes a machine learning system (e.g., classifier), which is trained with training data in one city (e.g., a cold northern city) is later employed in another city (e.g., a warm southern city) with vastly different weather, thereby providing a distribution of sensor data (e.g., digital image data) that is different than a distribution of the training data. As another example, this technical problem may also occur if a sensor is disposed at a different angle, thereby providing sensor data (e.g., digital image data) that has a distribution that is different than a distribution of training data due to the offset position of the sensor. Advantageously, the embodiments provide technical solutions of adapting machine learning systems from one distribution (associated with training) to another distribution (associated with run-time) with unlabeled input data (e.g., sensor data such as digital image data and/or digital audio data) such that the machine learning systems are enabled to operate effectively on the another distribution without dramatically decreased performance that would otherwise occur without the test-time adaptation disclosed herein.

As described in this disclosure, the embodiments provide several advantages and benefits. For example, the embodiments provide an advantageous view of test-time adaptation through the lens of the training losses's complex conjugate. In this regard, for example, the embodiments provide a general method of conjugate pseudo-labeling that derives an appropriate test-time adaptation loss for a given classifier. Across a variety of different training losses and distribution shifts, the embodiments provide consistent gains over alternatives. The embodiments establish and use at least a conjugate formalism, which was inspired by an intriguing set of meta-learning experiments that suggested that these conjugate pseudo-labels are somehow the “best” adaptation loss. The unsupervised conjugate pseudo-label loss roughly approximates the true supervised loss (if the embodiments had access to ground truth labels for the test dataset Dₜₑₛₜ in the target domain) around a well-trained classifier. For instance, in the case of cross-entropy loss, this conjugate pseudo-labeling approach corresponds exactly to self-training using labels given by the softmax applied to machine learning system h_{θ}(x). While this novel conjugate formulation indeed has this “simple” form for the case of cross-entropy loss, the real advantage comes in that it provides the “correct” pseudo-label for use with other losses, which may result in pseudo-labels different from the “common” softmax operation. Furthermore, although the embodiments described herein relate to adapting the machine learning system 140 in the presence of a distribution shift, the notion of conjugate pseudo-labels is more general, and may be extended to the standard semi-supervised learning setting.

Empirically, the effectiveness of embodiments with conjugate adaptation loss is verified across several datasets and training losses, such as cross-entropy and squared loss, along with the recently proposed PolyLoss (which itself has shown higher standard test accuracy on a wide range of vision tasks). Over several models, datasets and training losses, the embodiments with conjugate pseudo-labeling consistently outperform prior TTA losses and improves TTA performance over the current state of the art.

Furthermore, under natural conditions, this (unsupervised) conjugate function is viewed as a good local approximation to the original supervised loss and indeed, it recovers the “best” losses found by meta-learning. This leads to a generic recipe that can be used to find a good test-time adaptation (TTA) loss for any given supervised training loss function of a general class. Empirically, this conjugate pseudolabeling approach consistently dominates other TTA alternatives over a wide range of domain adaptation benchmarks. The embodiments are of particular interest when applied to classifiers trained with novel loss functions, e.g., the recently-proposed PolyLoss function, where it differs substantially from (and outperforms) an entropy-based loss. Further, this novel conjugate based approach can also be interpreted as a kind of self-training using a very specific soft label, which we refer to as the conjugate pseudolabel (or pseudo-reference data). Overall, the embodiments provide a broad framework for better understanding and improving test-time adaptation with unlabeled data in general.

That is, the above description is intended to be illustrative, and not restrictive, and provided in the context of a particular application and its requirements. Those skilled in the art can appreciate from the foregoing description that the present invention may be implemented in a variety of forms, and that the various embodiments may be implemented alone or in combination. Therefore, while the embodiments of the present invention have been described in connection with particular examples thereof, the general principles defined herein may be applied to other embodiments and applications without departing from the spirit and scope of the described embodiments, and the true scope of the embodiments and/or methods of the present invention are not limited to the embodiments shown and described, since various modifications will become apparent to the skilled practitioner upon a study of the drawings, specification, and following claims. Additionally or alternatively, components and functionality may be separated or combined differently than in the manner of the various described embodiments, and may be described using different terminology. These and other variations, modifications, additions, and improvements may fall within the scope of the disclosure as defined in the claims that follow.

What is claimed is:

1. A computer-implemented method for adapting a machine learning system that is trained with training data in a first domain to operate with sensor data in a second domain, the computer-implemented method comprising:
obtaining the sensor data from the second domain;
generating, via the machine learning system, prediction data based on the sensor data;
generating pseudo-reference data based on a gradient of a predetermined function evaluated with the prediction data;
generating loss data based on the pseudo-reference data and the prediction data;
updating parameter data of the machine learning system based on the loss data;
performing, via the machine learning system, a task in the second domain after the parameter data has been updated; and
controlling an actuator based on the task performed in the second domain.

2. The computer-implemented method of claim 1, wherein the machine learning system is a classifier configured to perform the task of generating output data that classifies input data.

3. The computer-implemented method of claim 1, wherein the machine learning system is trained in the first domain using the same predetermined function that is used to generate the pseudo-reference data in the second domain.

4. The computer-implemented method of claim 1, wherein the predetermined function is a loss function relating to the task performed by the machine learning system.

5. The computer-implemented method of claim 4, wherein the loss function is a cross-entropy loss function, a squared loss function, a hinge loss function, a tangent loss function, a polyloss function, or a logistic loss function.

6. The computer-implemented method of claim 1, wherein the parameter data is updated using a scaled gradient of the loss data.

7. The computer-implemented method of claim 1, wherein the sensor data includes digital image data or digital audio data obtained from one or more sensors.

8. A computer-implemented method for test-time adaptation of a machine learning system from a source domain to a target domain, the machine learning system having been trained with training data of the source domain, the computer-implemented method comprising:
obtaining sensor data from the target domain;
generating, via the machine learning system, prediction data based on the sensor data;
generating loss data based on a negative convex conjugate of a predetermined function applied to a gradient of the predetermined function, the predetermined function being evaluated based on the prediction data;
updating parameter data of the machine learning system based on the loss data;
performing, via the machine learning system, a task in the target domain after the parameter data has been updated; and
controlling an actuator based on the task performed in the target domain.

9. The computer-implemented method of claim 8, wherein the machine learning system is a classifier configured to perform the task of generating output data that classifies input data.

10. The computer-implemented method of claim 8, wherein the machine learning system is trained in the source domain using the same predetermined function.

11. The computer-implemented method of claim 8, wherein the predetermined function is a loss function relating to the task performed by the machine learning system.

12. The computer-implemented method of claim 11, wherein the loss function is a cross-entropy loss function, a squared loss function, a hinge loss function, a tangent loss function, a polyloss function, or a logistic loss function.

13. The computer-implemented method of claim 8, wherein the parameter data is updated using a scaled gradient of the loss data.

14. The computer-implemented method of claim 8, wherein the sensor data includes digital image data or digital audio data obtained from one or more sensors.

15. A system comprising:
a processor;
a non-transitory computer readable medium in data communication with the processor, the non-transitory computer readable medium having computer readable data including instructions stored thereon that, when executed by the processor, cause the processor to perform a method for adapting a machine learning system that is trained with training data in a first domain to operate with sensor data in a second domain, the method including:
obtaining the sensor data from the second domain;
generating, via the machine learning system, prediction data based on the sensor data;
generating pseudo-reference data based on a gradient of a predetermined function evaluated with the prediction data;
generating loss data based on the pseudo-reference data and the prediction data;
updating parameter data of the machine learning system based on the loss data; and
performing, via the machine learning system, a task in the second domain after the parameter has been updated.

16. The system of claim 15, wherein:
the machine learning system is a classifier configured to perform the task of generating output data that classifies input data; and
the predetermined function is a loss function relating to the task.

17. The system of claim 15, wherein the machine learning system is trained in the first domain using the same predetermined function that is used to generate the pseudo-reference data in the second domain.

18. The system of claim 15, wherein the parameter data is updated using a scaled gradient of the loss data.

19. The system of claim 15, further comprising:
an image sensor or a microphone;
wherein the sensor data includes digital image data from the image sensor or digital audio data obtained from the microphone.

20. The system of claim 15, further comprising:
an actuator,
wherein,
the processor is configured to generate control data based on the task performed by the machine learning system with respect to other sensor data in the second domain, and
the actuator is controlled based on the control data.
